(19) United States
(12) Patent Application Publication
(10) Pub. No.: US 2014/0261837 A1
(43) Pub. Date: Sep. 18, 2014

(54) HOSE JOINT INCORPORATING TWO OR MORE SWIVELS

(71) Applicant: Zodiac Pool Systems, Inc., Vista, CA (US)

(72) Inventors: Hendrikus Johannes van der Meijden, Midrand (ZA); Michael Edward Moore, Blairgowrie (ZA)

(73) Assignee: Zodiac Pool Systems, Inc., Vista, CA (US)

(21) Appl. No.: 14/208,618

(22) Filed: Mar. 13, 2014

Related U.S. Application Data
(60) Provisional application No. 61/779,904, filed on Mar. 13, 2013.
(60) Provisional application No. 61/804,342, filed on Mar. 22, 2013.

(51) Int. Cl. F16L 27/02

(52) U.S. Cl. CPC F16L 27/02
USPC 138/109; 285/272

(57) ABSTRACT

A hose joint for a pool cleaner or other apparatus that includes at least two swivels. The first swivel is configured to rotate about a first axis and the second swivel is configured to rotate about a second axis that is different from the first axis. In some embodiments, one of the swivels is configured to rotate approximately 360 degrees about its axis of rotation. In this way, the hose joint has at least two directions of freedom in at least two different planes that help the cleaner move independently from a hose attached to the hose joint.

### RELATED APPLICATIONS

This application claims the benefit of U.S. Provisional Ser. No. 61/779,904 filed Mar. 13, 2013 and titled “A Hose-Joint Incorporating Two Swivels” and U.S. Provisional Ser. No. 61/804,342 filed Mar. 22, 2013 and titled “Another Hose-Joint Incorporating Two Swivels,” the content of both of which is incorporated herein by reference.

### FIELD OF THE INVENTION

This application relates to hose-joints for pool cleaners.

### BACKGROUND

Hydraulic pool cleaners communicate with the pool pump via a hose and use the water flow from the pool pump to drive the cleaner around the pool. Movement of the pool cleaner is hindered and otherwise influenced by the hose it drags. Typically, it is preferable to attach the hose to the cleaner in a vertical orientation so the cleaner can swivel around the hose with less obstruction. But attaching the hose to the pool cleaner in a vertical orientation places several limitations on the cleaner. First, a vertical orientation prevents the cleaner from working in shallow water, as the hose needs to bend from the surface down to the cleaner and the cleaner has a tendency to tip due to strain from the bend of the hose. Second, the vertically oriented hose creates a substantial amount of drag, which can unsettle the hose and cause tipping. Third, the hose can hinder the cleaner's ability to turn and freely move around the pool, as the hose can get tangled and in general limit the cleaner's movement.

Thus, it is desirable to utilize a hose that is designed so that the cleaner's movements do not depend and/or are not limited by the hose.

### SUMMARY

The terms “invention,” “the invention,” “this invention” and “the present invention” used in this patent are intended to refer broadly to all of the subject matter of this patent and the patent claims below. Statements containing these terms should be understood not to limit the subject matter described herein or to limit the meaning or scope of the patent claims below. Embodiments of the invention covered by this patent are defined by the claims below, not this summary. This summary is a high-level overview of various aspects of the invention and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings and each claim.

This patent discloses a hose joint that has at least two distinct axes of rotation. In one embodiment, the hose joint has two swivels, a first swivel that rotates about a first axis and a second swivel that rotates about a second axis that is different from the first axis. A hose joint with at least two swivels maintains a high degree of rotational freedom and helps the cleaner (or other device with which the hose joint is used) move more independently of the hose coupled to the hose joint. By incorporating at least two cooperating but separate swivels into the joint, the hose joint is capable of swiveling in at least two directions of freedom about at least two separate axes and therefore can rotate throughout a full range of motion. In one embodiment, the hose joint includes a third axis of rotation, which may be located where the hose attaches to the hose joint.

In some embodiments, the swivels are configured so that the swivels rotate around their respective axes with low friction. For example, the swivels may include a plurality of ball bearings that reduce the friction between the various components as the swivels rotate.

In one non-limiting embodiment, the first axis of rotation is generally vertical and the second axis of rotation is generally horizontal. In another non-limiting embodiment, the first axis of rotation is generally vertical and the second axis of rotation is somewhere between approximately horizontal and approximately vertical, for example, but not limited to, between approximately 15 degrees from vertical and approximately 60 degrees from vertical.

Disclosed in one non-limiting embodiment is a hose joint for a pool cleaner comprising a first swivel comprising a first axis of rotation that is generally vertical and a second swivel comprising a second axis of rotation that is at an angle between generally vertical and generally horizontal.

In one embodiment, the angle is between approximately 15 degrees from vertical and approximately 60 degrees from vertical.

In one embodiment, the first swivel is capable of rotating approximately 360 degrees about the first axis of rotation.

In one embodiment, the second swivel is capable of rotating up to approximately 360 degrees about the second axis of rotation.

In one embodiment, the hose joint comprises a first opening proximate the second swivel and a second opening proximate the first swivel.

In one embodiment, the second swivel is mounted with respect to the first swivel so that the second swivel is generally central to the first axis of rotation of the first swivel.

In one embodiment, the hose joint comprises a plurality of ball bearings.

In one embodiment, the hose joint comprises at least one seal to minimize leakage.

In one embodiment, a fastener couples the second swivel to the hose joint, the fastener comprising a longitudinal axis that is coaxial with the second axis of rotation.

Also disclosed is a hose joint for a pool cleaner comprising a first swivel configured to rotate approximately 360 degrees about a first axis of rotation that is generally vertical and a second swivel configured to rotate approximately 360 degrees about a second axis of rotation that is between an angle of approximately 15 degrees and approximately 60 degrees from vertical.

Also disclosed is a pool cleaner comprising a hose and a hose joint, the hose joint further comprising a first opening; a second opening; a first swivel located between the first opening and the second opening and comprising a first axis of rotation, wherein the first opening is free to rotate approximately 360 degrees about the first axis of rotation; and a second swivel located between the first opening and the second opening and comprising a second axis of rotation, wherein the first opening is free to rotate about the second axis of rotation and wherein the second axis of rotation is between approximately 15 degrees from vertical and approximately 60 degrees from vertical.

In one embodiment, the first axis of rotation is generally vertical.

In one embodiment, the first axis of rotation is in a first plane and the second axis of rotation is in a second plane that is different from the first plane.

In one embodiment, the first opening is free to rotate approximately 360 degrees about the second axis of rotation.

In one embodiment, the second swivel is coupled to the hose joint at a center of the second swivel, the second axis of rotation extending through the center of the second swivel.

Also disclosed is a hose joint for a pool cleaner comprising: a first swivel comprising a first axis of rotation; and a second swivel comprising a second axis of rotation that is different from the first axis of rotation, wherein the first and second swivel each comprise a plurality of ball bearings and wherein a fastener couples the second swivel to the hose joint, the fastener comprising a longitudinal axis that is coaxial with the second axis of rotation.

In one embodiment, the first swivel is capable of rotating approximately 360 degrees about the first axis of rotation.

In one embodiment, the second swivel is capable of rotating at least approximately 30 degrees about the second axis of rotation.

In one embodiment, the second swivel is capable of rotating up to approximately 240 degrees about the second axis of rotation.

In one embodiment, the first axis of rotation is generally vertical.

In one embodiment, the second axis of rotation is generally horizontal.

In one embodiment, the hose joint comprises a first opening proximate the second swivel and a second opening proximate the first swivel.

In one embodiment, the first axis of rotation is substantially perpendicular to the second axis of rotation.

In one embodiment, the second swivel is mounted with respect to the first swivel so that longitudinal axes of the first opening and the second opening are generally parallel and coaxial.

In one embodiment, the hose joint comprises at least one seal to minimize leakage.

Also disclosed is a hose joint for a pool cleaner comprising: a first swivel configured to rotate only about a first axis of rotation that is generally vertical, wherein the first swivel is permitted to rotate approximately 360 degrees about the first axis; a second swivel configured to rotate only about a second axis of rotation that is generally horizontal, wherein the first and second swivel each comprise a plurality of ball bearings.

In one embodiment, the second swivel is configured to rotate at least approximately 30 degrees about the second axis of rotation.

In one embodiment, the hose joint further comprises a first opening proximate the second swivel and a second opening proximate the first swivel.

In one embodiment, the longitudinal axis of the first opening substantially aligns with a longitudinal axis of the second opening when the hose joint is in a first configuration.

In one embodiment, the second swivel is configured to rotate up to approximately 240 degrees about the second axis of rotation.

In one embodiment, the second swivel is coupled to the hose joint with a fastener, the fastener comprising a longitudinal axis that is coaxial with the second axis of rotation.

Also disclosed is a hydraulic pool cleaner comprising a hose and a hose joint, wherein the hose joint further comprises: a first opening coupled to the hose; a second opening; a first swivel located between the first opening and the second opening and comprising a first axis of rotation, wherein the second opening is free to rotate approximately 360 degrees about the first axis of rotation; and a second swivel located between the first opening and the second opening and comprising a second axis of rotation, wherein the first opening is free to rotate about the second axis of rotation.

In one embodiment, the first axis of rotation is generally vertical and the second axis of rotation is generally horizontal.

In one embodiment, the first axis of rotation is in a first plane; and the second axis of rotation is in a second plane that is generally perpendicular to the first plane.

In one embodiment, the first opening is free to rotate at least approximately 30 degrees about the second axis of rotation.

In one embodiment, the first opening is free to rotate up to approximately 240 degrees about the second axis of rotation.

In one embodiment, each of the first and second swivels comprises a plurality of ball bearings.

In one embodiment, the second swivel is coupled to the hose joint at a center of the second swivel, the second axis of rotation extending through the center of the second swivel.

### BRIEF DESCRIPTION OF THE DRAWINGS

Illustrative embodiments of the present invention are described in detail below with reference to the following drawing figures:

FIG. 1 is a perspective view of a hose joint according to one embodiment, shown in a first position.

FIG. 2 is a perspective view of the hose joint of FIG. 1, shown in a second position.

FIG. 3 is a section view of the hose joint of FIG. 1, shown in a substantially vertical position.

FIG. 4 is a section view of the hose joint of FIG. 1, shown in a generally horizontal position.

FIG. 5 is a partial section view of a hose joint according to another embodiment.

FIG. 6 is a top view of the hose joint of FIG. 5.

FIG. 7 is side perspective view of the hose joint of FIG. 5.

FIG. 8 is another side perspective view of the hose joint of FIG. 5, shown in a vertical position.

FIG. 9 is another side perspective view of the hose joint of FIG. 5, shown in a second position.

FIG. 10 is a section view of the hose joint of FIG. 5, shown in a vertical position.

FIG. 11 is a side view of a hose joint according to another embodiment, shown in a vertical position.

FIG. 12A is a side view of the hose joint of FIG. 11, shown in a substantially horizontal position.

FIG. 12B is a cross-sectional view of the hose joint of FIG. 12A.

FIG. 13 is another view of the hose joint of FIG. 11.

### DETAILED DESCRIPTION

The subject matter of embodiments of the present invention is described here with specificity to meet statutory requirements, but this description is not necessarily intended to limit the scope of the claims. The claimed subject matter may be embodied in other ways, may include different elements or steps, and may be used in conjunction with other existing or future technologies. This description should not be interpreted as implying any particular order or arrangement among or between various steps or elements except when the order of individual steps or arrangement of elements is explicitly described.

This patent discloses a hose joint that has at least two different swivels: one swivel that rotates around a first axis and a second swivel that rotates around a second axis. In some embodiments, the hose joint may include a third swivel that rotates about a third axis of rotation. If a third swivel is included, the third axis of rotation may be proximate the connection between the hose joint and the hose or at any other suitable location.

The hose joint described herein may be incorporated into hoses used with pool cleaners, although the hose joint described herein is not limited for use with pool cleaners and can be used in any suitable application. For example, but without limitation, the hose can be used with vacuum cleaners, fire hoses, or any other desired application that uses hoses or tubing. Although the application refers to conveyance of water through the hose joint, air or any other fluid may be conveyed through the disclosed hose joints.

FIGS. 1-4 illustrate a first embodiment of a hose joint 10. As shown in FIG. 3, hose joint 10 includes a first opening 12 where water (or other suitable fluid) enters or exits the hose joint 10 and a second opening 14 where water (or other suitable fluid) enters or exits the hose joint 10. As illustrated in FIGS. 1-2, hose 16 or other suitable tubing couples to the first opening 12 to route the water flow (or other suitable fluid) through the hose joint 10. Hose 16 may include threads that correspond to threads on the first opening 12 to couple the hose 16 to the first opening 12, although hose 16 can be coupled to the first opening 12 in any suitable way. Similarly, second opening 14 may include threads or other suitable coupling mechanism for coupling second opening 14 to a second hose or directly to a pool cleaner, vacuum cleaner, etc.

As shown in FIGS. 3-4, hose joint 10 includes a first swivel 26 that rotates about a first axis of rotation 18 and a second swivel 24 that rotates about a second axis of rotation 20. As illustrated, the first axis of rotation 18 is generally vertical, while the second axis of rotation 20 is generally horizontal and thus substantially normal to the first axis of rotation 18. In the illustrated embodiment, the second swivel 24 is mounted with respect to the first swivel 26 so that the longitudinal axes of the first opening 12 and the second opening 14 have the potential to be coaxial. Said another way, the first opening 12 and the second opening 14 have the potential to be oriented generally along the same axis when the longitudinal axes of the first opening 12 and the second opening 14 are parallel. As described in more detail below, the first and second axes can have other orientations.

FIGS. 1-2 illustrate hose joint 10 as second swivel 24 rotates about the second axis of rotation 20. Second swivel 24 may be configured so that it is permitted to rotate down as much as approximately 120 degrees about the second axis of rotation 20 from an initial position where the longitudinal axes of the first opening 12 and the second opening 14 are parallel or coaxial. The range of rotation of second swivel 24 is influenced in part by the geometry and arrangement of the first opening 12, the second opening 14 and/or the overall geometry of the body of the hose joint 10, as the lower surface of the first opening 12 and the body of the hose joint 10 serve as stops that limit rotation of the second swivel 24. In some embodiments, the second swivel 24 is configured so that it is only capable of rotating about second axis 20 and no other axes.

First swivel 26 is configured so that it is permitted to rotate approximately 360 degrees about the first axis of rotation 18. Because the first axis of rotation 18 is generally vertical, water (or other fluid) flows generally vertically between the first swivel 26 into second opening 14. In some embodiments, the first swivel 26 is configured so that it is only capable of rotating about first axis 18 and no other axes.

First swivel 26 allows freedom of rotation of the pool cleaner (or other device) that is independent of rotation/movement of the hose 16. By incorporating second swivel 24, hose 16 can rotate around second axis 20 without straining the cleaner (or other device) with forces inherent in a bending hose. As such, the cleaner (or other device) attached to the hose joint 10 is free from the influences a hose 16 exerts on it and is therefore able to obtain better drive and stability on the surface on which it moves. This in turn increases the traction and straight-line drive of the device and greatly enhances the device's agility. In addition, if the hose joint is used with a pool cleaner, the pool cleaner is able to operate in shallow water (for example, approximately 250 mm deep in some cases) and reach pool stair tops while in an upright position.

As illustrated in FIGS. 1 and 3, hose joint 10 also includes an optional third swivel 25 configured to rotate about third axis of rotation 27 (FIG. 3). Although third swivel 25 is illustrated as connected to the hose joint 10 via a snap fit connection, swivel 25 may include a plurality of ball bearings or otherwise be configured to generate minimal friction as it rotates.

Although hose joint 10 may have various configurations, hose joint 10 as illustrated in FIGS. 1-4 includes components 28, 30, 32, and 34 (FIG. 3). A plurality of ball bearings 36 may be positioned between components 28 and 30 to allow component 30 to rotate with respect to component 28 about the second axis of rotation 20 with reduced friction. Similarly, a plurality of ball bearings 38 may be positioned between components 32 and 34 to allow component 32 to rotate with respect to component 34 about the first axis of rotation 18 with reduced friction. As illustrated in FIG. 3, swivel joint 10 may also include one or more seals, such as seals 40, 42, 43, to help minimize leakage of water (or other fluid) flowing through the hose joint 10. Hose joint 10 may also include another plurality of ball bearings 44 to help minimize friction between components 46, 48 as they rotate with respect to one another.

As shown in FIG. 3, water (or other fluid) moving through hose joint 10 generally follows flow path 22. The flow path 22 may be altered by modifying the configuration of hose joint 10, including the geometry of one or both of the first and second swivels 24, 26. In some cases, it may be desirable for the flow path 22 to be as linear as possible and to limit turns and bends to minimize any hindrance to the flow path. In other cases, it may also (or alternatively) be desired to increase the flow area through hose joint 10. Flow through hose joint 10 can be increased by altering the geometry (for example, increasing the diameter and therefore the flow area) of the hose joint.

In some embodiments, the second swivel 24 is coupled to the hose joint 10 in any suitable way. For example, a fastener 41 or other suitable connection means may couple second swivel 24 to hose joint 10. As shown in FIG. 3, fastener 41 is coaxial with the second axis of rotation 20 so that the coupling at least partially aligns with the flow path 22 of the second swivel 24. Retaining/coupling the second swivel 24 to the hose joint 10 through the center of the second swivel 24 as illustrated in FIG. 3 provides second swivel 24 with a greater flow area to swivel ratio than if the second swivel 24 were retained/coupled outside of the flow path 22. In other words, fastening/coupling the second swivel 24 through its center allows the second swivel 24 to be smaller than, but still have the same flow area as, a swivel that is fastened/coupled outside the flow path of water or other fluid passing through the swivel.

In some embodiments, the length of the second opening 14 is minimized so that the hose joint 10 can be mounted as low as possible on the cleaner (or other device) to further minimize any lever effect that the hose 16 might have on the cleaner. Along these lines, it may be desirable to minimize the height (in the vertical direction) of the hose joint 10 to the extent possible.

FIGS. 5-10 show another embodiment of a hose joint 100. As shown in FIGS. 5 and 8, water (or other suitable fluid) flows between the first opening 112 and the second opening 114 into the hose joint 100. The first opening 112 may include threads or any other suitable mechanism for coupling a hose to the first opening 112. Similarly, the second opening 114 may include threads or other suitable coupling mechanism for coupling the second opening 114 to a second hose or directly to a pool cleaner, vacuum cleaner, etc.

As shown in FIGS. 5-7, hose joint 100 includes a first axis of rotation 118 and a second axis of rotation 120. As illustrated, the first axis of rotation 118 is generally vertical, while the second axis of rotation 120 is generally horizontal and thus normal to the first axis of rotation 118. As with axes 18 and 20, first and second axes 118, 120 may have other orientations. In some cases, first swivel 126 is only permitted to rotate about first axis 118 and no other axes, and second swivel 124 is only permitted to rotate about second axis 120 and no other axes.

FIGS. 7-9 illustrate hose joint 100 as second swivel 124 rotates around the second axis of rotation 120. Second swivel 124 may be configured so that it is permitted to rotate down as much as approximately 120 degrees about the second axis of rotation 120 from an initial position where the longitudinal axes of the first opening 112 and the second opening 114 are parallel or coaxial. The range of rotation of second swivel 124 is influenced in part by the geometry and arrangement of the first opening 112 and/or the second opening 114, as the lower surface of the first opening 112 and the body of the hose joint 100 serve as stops that limit rotation of the second swivel 124. As with swivel 26, first swivel 126 is configured so that it is permitted to rotate approximately 360 degrees about the first axis of rotation 118.

As shown in FIG. 5, water (or other fluid) moving through hose joint 100 generally follows flow path 122. The flow path 122 may be altered by modifying the configuration of hose joint 100, including one or both of the first and second swivels 124, 126.

FIGS. 11-13 show another embodiment of a hose joint 200. As shown in FIG. 11, water (or other suitable fluid) flows through hose joint 200 between a first opening 212 and a second opening 214. First opening 212 may include threads or any other suitable mechanism for coupling a hose to first opening 212. Similarly, second opening 214 may include threads or other suitable coupling mechanism for coupling second opening 214 to a second hose or directly to a pool cleaner, vacuum cleaner, etc.

As shown in FIG. 11, hose joint 200 includes a first axis of rotation 218 and a second axis of rotation 220. As illustrated, the first axis of rotation 218 is generally vertical, while the second axis of rotation 220 is at an angle 228 relative to the first axis of rotation 218. Any suitable split angle may be used. For example, although angle 228 is illustrated as being approximately 50 degrees from vertical, any suitable angle could be used including between approximately 15 degrees and approximately 60 degrees from vertical.

A split angle of approximately 50 degrees from vertical allows the second swivel 224 to rotate as far down as approximately 100 degrees from an initial position where the longitudinal axes of first opening 212 and second opening 214 are parallel or coaxial, while a split angle of approximately 45 degrees from vertical allows the second swivel 224 to rotate approximately 90 degrees from an initial position where the longitudinal axes of first opening 212 and second opening 214 are parallel or coaxial, a split angle of approximately 55 degrees from vertical allows the second swivel 224 to rotate approximately 110 degrees from an initial position where the longitudinal axes of first opening 212 and second opening 214 are parallel or coaxial, a split angle of approximately 60 degrees from vertical allows the second swivel 224 to rotate approximately 120 degrees from an initial position where the longitudinal axes of first opening 212 and second opening 214 are parallel or coaxial, a split angle of approximately 35 degrees from vertical allows the second swivel 224 to rotate approximately 70 degrees from an initial position where the longitudinal axes of first opening 212 and second opening 214 are parallel or coaxial and so forth.

FIGS. 11-13 illustrate hose joint 200 as second swivel 224 rotates around the second axis of rotation 220. Second swivel 224 may be configured so that the longitudinal axis of the first opening 212 is permitted to rotate about the second axis of rotation 220 in the directions indicated by arrows 232 (FIG. 12A) from an initial position where the longitudinal axes of first opening 212 and second opening 214 are parallel or coaxial to an angle as far down as approximately 120 degrees from the initial position. While both the first swivel 226 and the second swivel 224 can rotate approximately 360 degrees about their axes, the rotation limit of first opening 212 is determined by the angle of the axis 220 of the second swivel 224.

First swivel 226 is configured so that it is permitted to rotate in the directions indicated by arrows 230 (FIG. 12A) approximately 360 degrees about the first axis of rotation 218. In some cases, first swivel 226 is only permitted to rotate about first axis 218 and no other axes, and second swivel 224 is only permitted to rotate about second axis 220 and no other axes.

As shown in FIGS. 11 and 12B, water (or other fluid) moving through hose joint 200 generally follows flow path 222. By offsetting the second axis of rotation 220 from generally horizontal, the flow path 222 is permitted to follow a generally more linear path with less bends than if the two axes were normal to one another. Put another way, splitting the plane of rotation of the second swivel 224 at an angle allows the two swivels 224, 226 to be located outside of the flow path 222 and minimize the disruption of the flow path, even when the hose joint 200 is in a non-vertical position as shown in FIG. 12B.

The dual swivel arrangement disclosed herein provides a better range of motion than a traditional ball joint. Although a traditional ball joint is capable of rotating about a single point in various directions, the range of rotation is limited in all such directions. In particular, a traditional ball joint is not able to rotate 180 degrees or more in any given direction because the geometry of the ball joint limits its range of motion. Even more specifically, the stem of the ball eventually hits the socket with which the ball is housed, prohibiting movement past a certain point. Moreover, ball joints are prone to leakage, whereas the hose joint disclosed herein can be constructed to minimize both friction and leakage.

Different arrangements of the components depicted in the drawings or described above, as well as components and steps not shown or described are possible. Similarly, some features and subcombinations are useful and may be employed without reference to other features and subcombinations. As one example, as mentioned above, the hose joint may have more than two swivels and more than two axes of rotation. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

That which is claimed is:

1. A pool cleaner hose joint comprising:
a first swivel comprising a first axis of rotation; and
a second swivel comprising a second axis of rotation that is different from the first axis of rotation.

2. The pool cleaner hose joint of claim 1, wherein the first axis of rotation is generally vertical.

3. The pool cleaner hose joint of claim 2, wherein the second axis of rotation is generally horizontal.

4. The pool cleaner hose joint of claim 1, further comprising a first opening proximate the second swivel and a second opening proximate the first swivel.

5. The pool cleaner hose joint of claim 1, wherein the first axis of rotation is substantially perpendicular to the second axis of rotation.

6. The pool cleaner hose joint of claim 4, wherein the second swivel is mounted with respect to the first swivel so that longitudinal axes of the first opening and the second opening are generally coaxial.

7. A hose joint for a pool cleaner comprising:
a first swivel configured to rotate only about a first axis of rotation that is generally vertical; and
a second swivel configured to rotate only about a second axis of rotation that is generally horizontal.

8. The hose joint of claim 7, further comprising a first opening proximate the second swivel and a second opening proximate the first swivel.

9. The hose joint of claim 8, wherein a longitudinal axis of the first opening substantially aligns with a longitudinal axis of the second opening when the hose joint is in a first configuration.

10. A hydraulic pool cleaner comprising a hose and a hose joint, wherein the hose joint further comprises:
a first opening coupled to the hose;
a second opening;
a first swivel located between the first opening and the second opening and comprising a first axis of rotation; and
a second swivel located between the first opening and the second opening and comprising a second axis of rotation that is different from the first axis of rotation, wherein the first opening is free to rotate about the second axis of rotation.

11. The hydraulic pool cleaner of claim 10, wherein the first axis of rotation is generally vertical and the second axis of rotation is generally horizontal.

12. The hydraulic pool cleaner of claim 10, wherein:
the first axis of rotation is in a first plane; and
the second axis of rotation is in a second plane that is generally perpendicular to the first plane.
